(19) United States
(12) Patent Application Publication
(10) Pub. No.: US 2005/0089040 A1
(43) Pub. Date: Apr. 28, 2005

(54) Method for providing service of multimedia mail box to support user mobility

(75) Inventor: Hyo-Soeng Kim, Seoul (KR)

Correspondence Address: HARNESS, DICKEY & PIERCE, P.L.C., P.O. BOX 828, BLOOMFIELD HILLS, MI, 48303, US

(73) Assignee: C and S Technology Co., Ltd., Seoul (KR)

(21) Appl. No.: 10/976,256

(22) Filed: Oct. 28, 2004

(30) Foreign Application Priority Data
Oct. 28, 2003 (KR) 10-2003-75376

(51) Int. Cl. H04L 12/28; H04L 12/56

(52) U.S. Cl. 370/395.2

(57) ABSTRACT

Disclosed is a method for providing service of a multimedia mail box in VOIP service. A service providing method applied to a terminal that processes a multimedia message, comprises the steps of: (a) being in a state in which a terminal at a receiving side cannot make a response to a request from a transmitting side; (b) receiving a call setup request from the transmitting side when a user of the terminal at the receiving side is absent; (c) receiving the call setup request from the transmission side when the user of the terminal at the receiving side is in a busy state; and (d) performing a connection to a location information server and a multimedia mail box according to the presence of a response, from the terminal at the receiving side, to the request from the transmitting side at the steps (a), (b) and (c).

### BACKGROUND OF THE INVENTION

1. Field of the Invention

The present invention relates to a method for providing service of a multimedia mail box in VOIP (Voice over Internet Protocol) service, and more particularly to technology capable of recognizing capabilities of video phones or mobile communication terminals in a PSTN (Public Switched Telephone Network), mobile communication network and Internet network and providing an appropriate multimedia message (text, images, voice, video, etc.) to an opposite party when the opposite party is absent.

2. Description of the Related Art

Conventionally, a multimedia mailbox provides a multimedia mailbox function between compatible terminals. However, this method disables multimedia message transmission between different communication networks.

Without taking into account states of various multimedia terminals (such as a video phone, mobile communication terminal, PSTN (Public Switched Telephone Network) terminal and messenger) of a user, the prior art sends a request for a response to only a pre-selected single terminal.

In particular, there is a problem in that a multimedia message may not be immediately sent because it is difficult for a user making a request for a response to recognize a type of terminal of a called party.

FIG. 1 is a block diagram illustrating a conventional connection state between different communication networks. A mobile communication terminal 10 is connected to a wireless bridge 20a in a wireless fashion. The wireless bridge 20a is connected to a mobile communication network 30 in the wireless fashion. In this case, an Internet network 40 and a PSTN 50 are connected to the wireless bridge 20a and a wireless bridge 20b, respectively. As the Internet network 40 is connected to a soft switch 60 and the wireless bridge 20a or 20b is provided to carry out a conversion operation between different networks, communication between the different networks can be smoothly accomplished.

The current mailbox function mainly provides service of a text message and voice mailbox to a limited number of users using mobile communication. An existing system transmits a message to a single terminal of a designated single user. In this case, a determination cannot be made as to whether or not the user's terminal can immediately receive the message. The message may not be appropriately transmitted due to a terminal state of a receiver or a different network connection.

The present invention enables a user to determine a different network and reception capability of a terminal and to receive a message anywhere and anytime.

### SUMMARY OF THE INVENTION

Therefore, the present invention has been made in view of the above and other problems, and it is an object of the present invention to provide a method for providing service of a multimedia mail box that can provide multimedia services for text, images, voice, video and etc. irrespective of terminal capabilities associated with various communication means capable of accommodating all of the conventional PSTN (Public Switched Telephone Network), mobile communication network and Internet network.

In accordance with an aspect of the present invention, the above and other objects can be accomplished by the provision of a service providing method applied to a terminal that processes a multimedia message, comprising the steps of: (a) being in a state in which a terminal at a receiving side cannot make a response to a request from a transmitting side; (b) receiving a call setup request from the transmitting side when a user of the terminal at the receiving side is absent; (c) receiving the call setup request from the transmission side when the user of the terminal at the receiving side is in a busy state; and (d) performing a connection to a location information server and a multimedia mail box according to the presence of a response, from the terminal at the receiving side, to the request from the transmitting side at the steps (a), (b) and (c).

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a conventional connection state between different communication networks;

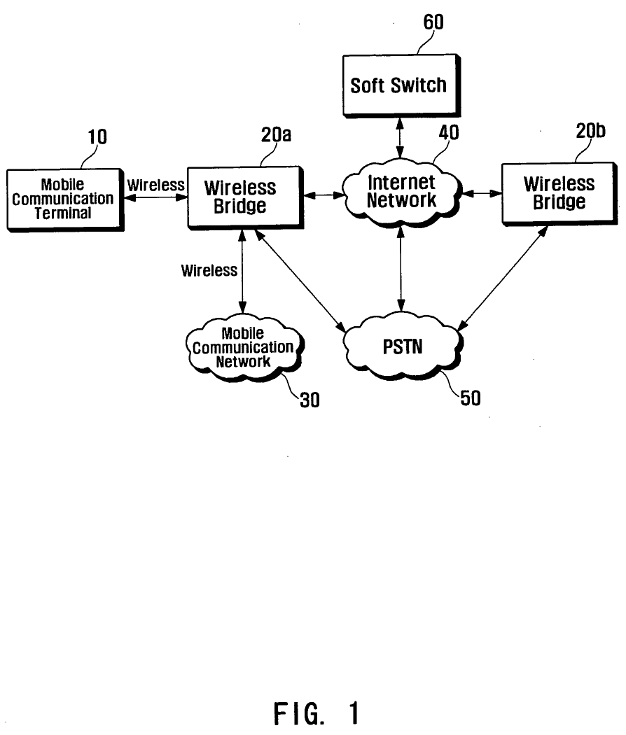

FIG. 2 is an explanatory view illustrating a service providing system in accordance with the present invention;

FIG. 3 is a flowchart illustrating an operation process in the case where a receiving terminal is registered in the service providing system in accordance with the present invention;

FIG. 4 is a flowchart illustrating an operation process in the case where a receiving terminal is not registered in the service providing system in accordance with the present invention; and

FIG. 5 is a flowchart illustrating an operation process of a multimedia mail box in accordance with the present invention.

### DESCRIPTION OF THE PREFERRED EMBODIMENTS

Now, preferred embodiments of the present invention will be described in detail with reference to the annexed drawings.

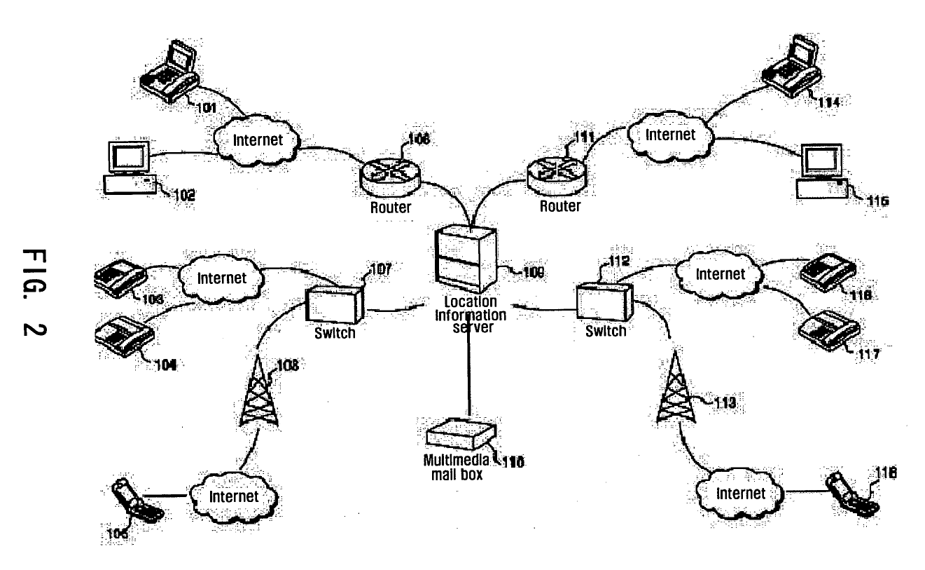

FIG. 2 is an explanatory view illustrating a service providing system in accordance with the present invention.

The system for providing service of a multimedia mail box in accordance with the present invention will be described. It is assumed that a video telephone 101 connected to an Internet network has a message to be urgently sent to a user or receiver located a long distance away. To send the message, a transmitter confirms a terminal state of the receiver through a location information server 109. The transmitter determines, through the location information server 109, whether the receiver currently holds an Internet video phone 114. The transmitter confirms information through the location information server 109 and the transmitter attempts communication to transmit the multimedia message to the Internet video phone 114 of the receiver.

Here, when attempting the communication with the Internet video phone 114 of the receiver, the transmitter may receive a message indicating that the Internet video phone 114 of the receiver is currently in a busy state. At this point, the transmitter receives a message indicating that a call with the receiver is impossible, and sends a multimedia message to be transmitted to the Internet video phone 114 of the receiver. Then, the receiver receives a notice message indicating that the multimedia message has been received after the call is terminated, and confirms a video message received from the transmitter through a video message mail box mounted in the video phone 114.

On the other hand, when the transmitter sends a receiver information request to the location information server 109 in order to be connected to the receiver, it transmits, to a multimedia mail box 110, the multimedia message to be sent to the receiver if the receiver does not have a terminal capable of receiving the multimedia message. Subsequently, when the receiver registers a terminal capable of receiving the multimedia message in the location information server 109, the multimedia mail box 110 informs the receiver that a new multimedia message from the transmitter has reached, such that the multimedia message appropriate for the receiver's terminal capability can be sent to the receiver.

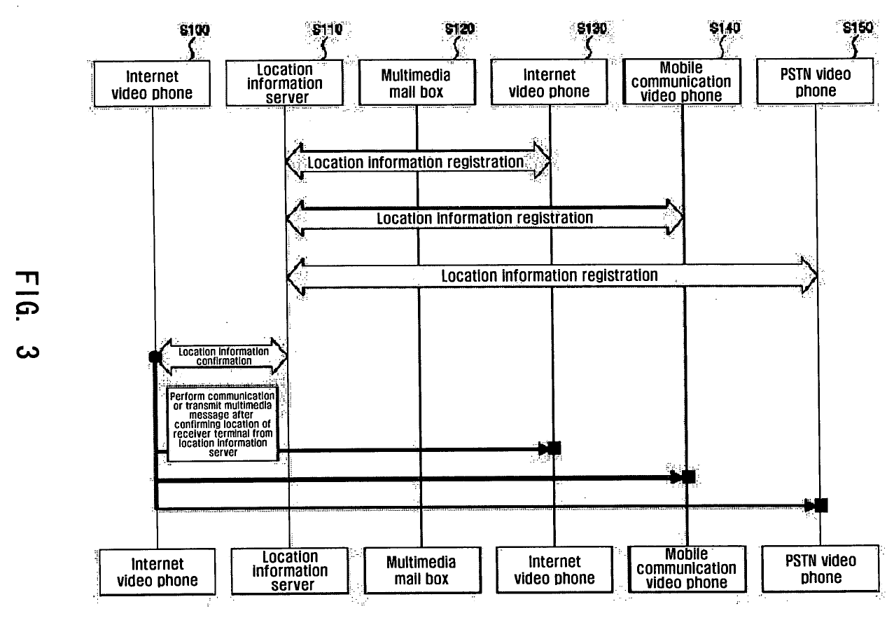

Next, an operation process in the case where a receiving terminal is registered in the service providing system to which the present invention is applied will be described with reference to FIG. 3.

When confirming a receiver's terminal through the location information server 109 and communicating with the receiver's terminal, a transmitter recognizes the receiver's terminal capability and attempts communication using a communication protocol appropriate for a corresponding terminal. For this, communication protocol conversion operates through a well-known protocol conversion soft switch. This operation process is as follows.

1) The receiver registers receiving terminals S130 to S150 (including an Internet video phone, mobile communication video phone and PSTN video phone) in a location information server S110. Here, there is given an example of the Internet video phone S130 registered in the location information server S110.

2) A transmitter of an Internet video phone S100 confirms information indicating that the receiver has registered the Internet video phone S130, from the location information server S110.

3) As the receiver uses the Internet video phone S130, the transmitter sends a communication request to the Internet video phone S130 of the receiver.

4) Subsequently, the transmitter and the receiver communicate with each other on a scenario-by-scenario basis.

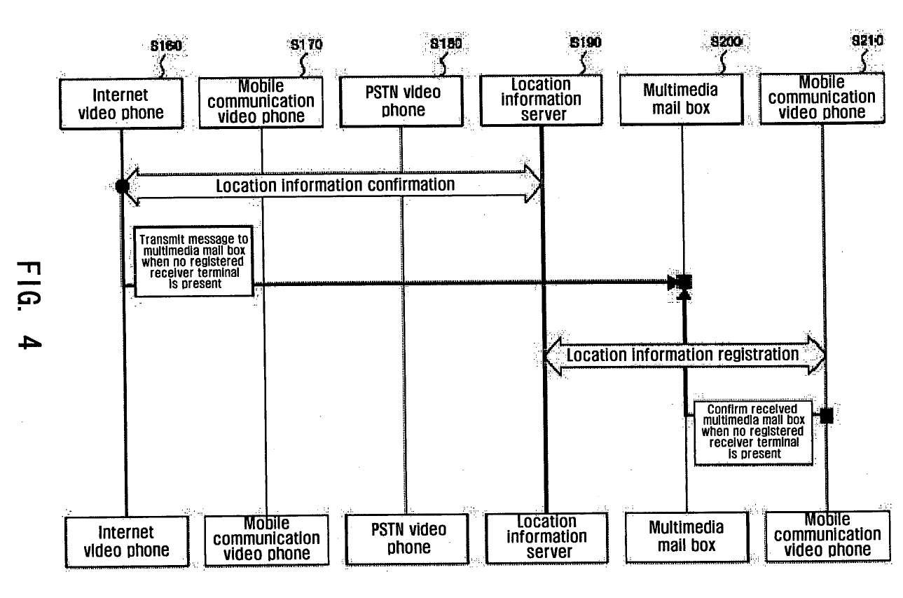

Next, an operation process in the case where a receiving terminal is not registered in the service providing system to which the present invention is applied will be described with reference to FIG. 4.

FIG. 4 shows a scenario in the case where the receiver has a plurality of terminals but does not have a currently operable terminal serving as a receiving terminal registered in a location information server S190.

When the transmitter send a request for terminal state information of the receiver to the location information server S190 in order to attempt communication with the receiver using an Internet video phone S160, the transmitter receives information indicating that there is not a registered terminal of the receiver and sends a communication request to a multimedia mail box S200 so that the multimedia message can be sent. This operation process is as follows.

1) The transmitter sends a request for the terminal state information of the receiver to the location information server S190 using the Internet video phone S160.

2) The location information server S190 informs the transmitter's Internet video phone S160 of information indicating that the receiver's terminal is not currently registered.

3) The transmitter confirms the information indicating that the receiver's terminal is not registered, and sends the multimedia message to the multimedia mail box S200 so that the message can be sent to the receiver.

4) The receiver registers a mobile communication video phone S210 serving as a currently available terminal in the location information server S190.

5) The location information server S190 notifies the mobile communication video phone S120 of information indicating that the multimedia message transmitted from the Internet video phone S160 of the transmitter has been stored in the multimedia mail box S200.

6) The receiver communicates with the multimedia mail box S200 using the mobile communication video phone S210 and confirms the received multimedia message.

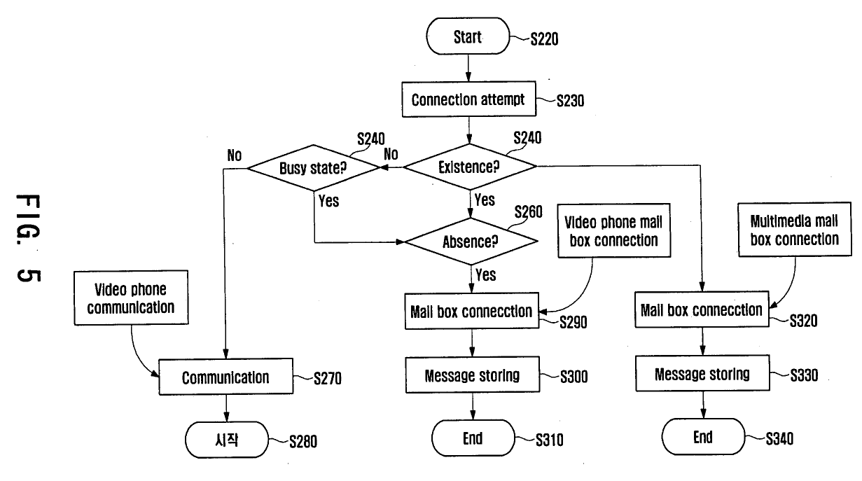

Next, an operation process of the multimedia mail box to which the present invention is applied will be described with reference to FIG. 5.

An operation flowchart of the multimedia mail box in accordance with the present invention is an operation scenario for processing a multimedia message when the receiver's terminal is the Internet video phone. The operation of the Internet video phone is divided into three operations according to the presence of a receiving terminal, an absent state, and a busy state.

First, the operation is initiated when a communication request is received from the transmitter (S220).

It is determined whether or not a response to the communication request is possible (S230 and S240). At this point, when the response to the communication request is impossible, the communication request is sent to the multimedia mail box.

If the terminal has been determined to be present, a determination is made as to whether the receiver can make the response (S260). When the receiver cannot make the response, the transmitter is connected to the multimedia mail box embedded in the video phone.

It is determined whether or not the receiver can communicate with the transmitter (S250). When the receiver can communicate with the transmitter, an operating state transits to a call state (S270), such that a call is in progress between the transmitter and the receiver.

When the receiver is in a busy state (S250), the transmitter is connected to the mail box of the video phone (S290), and stores the multimedia message to be sent to the receiver in the mail box of the video phone (S300). After the busy state is terminated, information indicating that the multimedia message from the transmitter has been received is provided to the receiver.

When the transmitter cannot communicate with the receiver because the receiver is absent (S260), the transmitter is connected to the mail box of the video phone as in the busy state (S290), and stores the multimedia message to be sent to the receiver in the mail box of the video phone (S300). A notice message is provided to the receiver so that the receiver can confirm the multimedia message.

When the receiver's terminal cannot be identified (S240), the transmitter is connected to the multimedia mail box. At this point, when the transmitter has been connected to the multimedia mail box (S320), the multimedia message to be sent to the receiver is stored in the multimedia mail box and then the operation is terminated (S330 and S340).

As apparent from the above description, a method for providing service of a multimedia mail box that can ensure compatibility between different networks (e.g., a PSTN (Public Switched Telephone Network), Internet network and mobile communication network) and different terminals (e.g., a PSTN phone, mobile communication terminal and PDA (Personal Digital Assistant), instant messenger, video phone or e-mail) by registering a plurality of terminals based on a single ID (Identity) associated with a user holding various communication means, and that can provide, to a transmitter desiring to send a multimedia message, terminal information of a receiver capable of immediately giving a response.

Furthermore, the present invention can provide service capable of recognizing a type and service capability of the terminal of the receiver through terminal information of the receiver anywhere and anytime, and appropriately sending a multimedia message.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

The entire content of Priority Document No. 10-2003-75376 is incorporated herein by reference.

1. A service providing method applied to a terminal that processes a multimedia message, comprising the steps of:
(a) being in a state in which a terminal at a receiving side cannot make a response to a request from a transmitting side;
(b) receiving a call setup request from the transmitting side when a user of the terminal at the receiving side is absent;
(c) receiving the call setup request from the transmission side when the user of the terminal at the receiving side is in a busy state; and
(d) performing a connection to a location information server and a multimedia mail box according to the presence of a response, from the terminal at the receiving side, to the request from the transmitting side at the steps (a), (b) and (c).

2. The service providing method of claim 1, further comprising the step of:
(e) after the step (a) is performed, by a location information server, notifying the transmitting side of state information associated with the terminal at the receiving side and connecting a terminal at the transmitting side to the multimedia mail box.

3. The service providing method of claim 2, further comprising the step of:
(f) when the terminal at the transmitting side is connected to the multimedia mail box, providing state information associated with the terminals at the transmitting and receiving sides and storing a multimedia message to be sent to the receiving side in the multimedia mail box.

4. The service providing method of claim 1, further comprising the step of:
(g) after the step (b) is performed, storing a multimedia message to be sent to the receiving side in a multimedia mail box embedded in the terminal at the receiving side in a state in which the terminal at the transmitting side is not connected to a special multimedia mail box.

5. The service providing method of claim 1, further comprising the step of:
(h) after the step (c) is performed, storing a multimedia message to be sent to the receiving side in a multimedia mail box embedded in the terminal at the receiving side in a state in which the terminal at the transmitting side is not connected to a special multimedia mail box.

6. A service providing method applied to a mail box storing a multimedia message, comprising the steps of:
storing user state information associated with terminals at transmitting and receiving sides; and
classifying and storing at least one multimedia message that the terminal at the transmitting side desires to send, according to text, images, voice and video.

7. A service providing method applied to a service system for providing location and state information of a terminal, comprising the steps of:
(a) registering the terminal in the service system;
(b) correcting registration information of the terminal in the service system;
(c) canceling the terminal's registration in the service system; and
(d) varying information registered in a location information server according to a state of the terminal at the steps (a), (b) and (c).

8. The service providing method of claim 7, wherein the step (a) comprises the step of:
allowing a user to register, in the location information server, one or more terminals capable of immediately giving a response among the user's terminals; and to periodically exchange terminal state information with the location information server through communication.

9. The service providing method of claim 7, wherein the step (b) comprises the step of:
allowing a user to change information of the terminal registered in the location information server and to periodically exchange terminal state information with the location information server through communication.

10. The service providing method of claim 7, wherein the step (c) comprises the step of:
allowing a user to delete information of all terminals registered in the location information server and to provide information indicating that a terminal capable of giving a response is not present.
